(19) United States
(12) Patent Application Publication
(10) Pub. No.: US 2026/0322626 A1
(43) Pub. Date: Oct. 15, 2026

(54) CERTIFICATE MANAGEMENT FOR NETWORK FUNCTIONS

(71) Applicant: Nokia Technologies Oy, Espoo (FI)

(72) Inventors: Sireesha BOMMISETTY, Bangalore (IN); Mallikarjunudu MAKHAM, Bangalore (IN); Topuri BRAHMAIAH, Bangalore (IN); German PEINADO GOMEZ, Wroclaw (PL); Jing Ping, Chengdu (CN)

(21) Appl. No.: 19/117,355

(22) PCT Filed: Sep. 30, 2022
(86) PCT No.: PCT/CN2022/123562

§ 371 Date: Mar. 31, 2025

(51) Int. Cl. H04L 9/32; H04L 9/40

(52) U.S. Cl. CPC H04L 9/3268; H04L 9/40; H04L 63/0823; H04L 63/102

(57) ABSTRACT

Embodiments of the present disclosure relate to certificate management for network functions (NFs). A first core network device receives, from a second core network device, status information of a certificate of the second core network device. The first core network device further stores the status information in a profile of the second core network device. As such, with the status information of the certificate being stored in the profile of the second core device, the certificate of the second core device can be managed in association with the second core network device itself, thereby improving efficiency of certificate management for the NFs.

### FIELD

Various example embodiments relate to the field of telecommunication and in particular, to methods, devices, apparatuses and a computer readable storage medium for certificate management for network functions.

### BACKGROUND

The 5G Service-Based Architecture (SBA) has been defined to enable flexible and scalable deployments using virtualization and container technologies and cloud-based processing platforms. In the 5G SBA, services are provided by network functions (NFs) via transport layer security (TLS) connections. The TLS connection is established between a NF service producer and a NF service customer as a pre-requisite before the NF service customer accesses the service provided by the NF service producer.

However, the NF service customer needs a valid certificate to establish the TLS connection with the NF service producer, thus certificate management for the NFs needs to be well investigated to reduce or avoid the NF service failure.

### SUMMARY

In general, example embodiments of the present disclosure provide a solution of certificate management for network functions.

In a first aspect, there is provided a first core network device. The first core network device comprises at least one processor and at least one memory storing instructions that, when executed by the at least one processor, cause the first core network device at least to: receive, at the first core network device and from a second core network device, status information of a certificate of the second core network device; and store the status information in a profile of the second core network device at the first core network device.

In a second aspect, there is provided a second core network device. The second core network device comprises at least one processor; and at least one memory storing instructions that, when executed by the at least one processor, cause the second core network device at least to: obtain, at the second core network device, status information of a certificate of the second core network device; and transmit, at the second core network device, the status information to a first core network device configured to store the status information in a profile of the second core network device.

In a third aspect, there is provided a method. The method comprises receiving, at a first core network device and from a second core network device, status information of a certificate of the second core network device; and storing the status information in a profile of the second core network device at the first core network device.

In a fourth aspect, there is provided a method. The method comprises obtaining, at a second core network device, status information of a certificate of the second core network device; and transmitting, at the second core network device, the status information to a first core network device configured to store the status information in a profile of the second core network device.

In a fifth aspect, there is provided an apparatus comprising: means for receiving, at a first core network device and from a second core network device, status information of a certificate of the second core network device; and means for storing the status information in a profile of the second core network device at the first core network device.

In a sixth aspect, there is provided an apparatus comprising: means for obtaining, at a second core network device, status information of a certificate of the second core network device; and means for transmitting, at the second core network device, the status information to a first core network device configured to store the status information in a profile of the second core network device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, at a first core network device and from a second core network device, status information of a certificate of the second core network device; and store the status information in a profile of the second core network device.

In a ninth aspect, there is provided a computer program comprising instructions, which, when executed by an apparatus, cause the apparatus at least to: obtain, at a second core network device, status information of a certificate of the second core network device; and transmit the status information to a first core network device configured to store the status information in a profile of the second core network device.

In a tenth aspect, there is provided a first core network device comprising: receiving circuitry configured to receive, at a first core network device and from a second core network device, status information of a certificate of the second core network device; and storing circuitry configured to store the status information in a profile of the second core network device.

In an eleventh aspect, there is provided a second core network device comprising: obtaining circuitry configured to obtain, at a second core network device, status information of a certificate of the second core network device; and transmitting circuitry configured to transmit the status information to a first core network device configured to store the status information in a profile of the second core network device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of a process of certificate management for network functions according to some embodiments of the present disclosure;

FIG. 3 illustrates another example of a process of certificate management for network functions according to some embodiments of the present disclosure;

FIG. 4 illustrates a flowchart of a method implemented at a first core network device according to some embodiments of the present disclosure;

FIG. 5 illustrates a flowchart of a method implemented at a second core network device according to some embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, in the 5G SBA the services are provided by NFs. Specifically, every NF registers its profile with a network repository function (NRF) and a NF can discover another NF with help of the NRF. As a part of a discovery procedure, the NRF receives a NF discovery request from a source NF (i.e., NF service customer) and chooses all target NFs (i.e., NF service producers) matching the request as a response to the NF discovery request. Upon discovering the target NF(s), the source NF sends an access token request to the NRF for an access token for availing service(s) of the target NF(s). By using the access token issued by the NRF, the source NF accesses the service(s) provided by the target NF(s) via the TLS connection established as a pre-requisite.

Currently, the NRF does not have any provision to check if the NF service producer has a valid certificate for establishment of the TLS connection while responding to the NF discovery request, the access token request, or a subscription request from the NF service customer. Thus the NF service producer with an invalid certificate may be provided as a response to the request from the NF service customer, thereby resulting into NF service failures since the NF service producer cannot establish the TLS connection with the NF service customer. This problem may be also evident in an indirect communication where a service communication proxy (SCP) on behalf of the NF service producer has an invalid certificate that the NRF does not identify.

Some solutions have been proposed for certificate management for the NFs. In an example solution, while receiving the NF discovery request, the access toke request or any other service related request from the NF service customer, the NRF may query certificate status of the NF service producer. For example, when receiving an access token request specifying a target NF type, the NRF may query a certificate status server for all the NF service producers belonging to the target NF type before providing an access token response. However, querying the certificate status of each matching NF service producer for each received request may cause a heavy load on the NRF and also delay the response.

Alternatively, an additional NF may be introduced to coordinate between a NF lifecycle and a certificate lifecycle. However, this may cause additional cost to the operator.

According to embodiments of the present disclosure, there is providing a solution of certificate management for NFs. In this solution, a first core network device receives, from a second core network device, status information of a certificate of the second core network device. The first core network device further stores the status information in a profile of the second core network device. As such, with the status information of the certificate being stored in the profile of the second core network device, the certificate of the second core network device can be managed in association with the second core network device itself, thereby improving efficiency of certificate management for the NFs.

Principle and embodiments of the present disclosure will be described in detail below with reference to the accompanying drawings. However, it is to be noted that these embodiments are illustrated as examples and not intended to limit scope of the present application in any way.

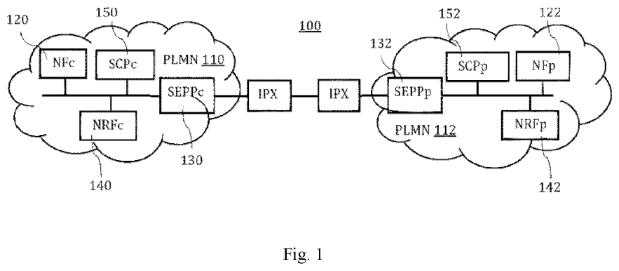

Reference is first made to FIG. 1, which illustrates an example communication system 100 in which embodiments of the present disclosure may be implemented. FIG. 1 illustrates an example system, comprising two public land mobile networks, PLMNs, 110, 112, each equipped with a network function, NF, 120, 122. A network function may refer to an operational and/or a physical entity. A network function may be a specific network node or element, or a specific function or set of functions carried out by one or more entities, such as virtualized network elements, VNFs. One physical node may be configured to perform plural NFs. A network function can be implemented either as a network element on a dedicated hardware, as a software instance running on a dedicated hardware, or as a virtualized function instantiated on an appropriate platform, e.g. on a cloud infrastructure. Examples of such network functions include a resource control or management function, session management or control function, interworking, data management or storage function, authentication function or a combination of one or more of these functions.

In case of 3GPP 5G SBA, core network NFs may comprise at least some of an access and mobility management function, AMF, a session management function, SMF, a network slice selection function, NSSF, a network exposure function, NEF, a network repository function, NRF, a unified data management, UDM, an authentication server function, AUSF, a policy control function, PCF, and an application function, AF. The PLMNs may each further comprise a security edge protection proxy, SEPP, 130, 132 configured to operate as a security edge node or gateway. The NFs may communicate with each other using representational state transfer application programming interfaces, for example. These may be known as Restful APIs. Further examples of NFs include NFs related to gaming, streaming or industrial process control. The system may comprise also nodes from 3G or 4G node systems, such as home subscriber server, HSS, and a suitable interworking function for protocol translations between e.g. diameter and REST API Json. While described herein primarily using terminology of 5G systems, the principles of the invention are applicable also to other communication networks using proxies as described herein, such as 4G networks, 6G networks, and non-3GPP networks, for example.

While the example of FIG. 1 has two PLMNs, 110, 122, in general at least some embodiments of the invention may be practiced in a single PLMN, which need not necessarily have SEPPs. In an inter-PLMN case, the SEPP 130, 132 is a network node at the boundary of an operator's network that may be configured to receive a message, such as an HTTP request or HTTP response from an NF, to apply protection for sending and to forward the reformatted message through a chain of intermediate nodes, such as IP exchanges, IPX, towards a receiving SEPP. The receiving SEPP receives a message sent by the sending SEPP and forwards the message towards an NF within its operator's network, e.g. the AUSF.

In the example of FIG. 1, an NF service may be provided for a service-consuming NF by a service-producing NF, henceforth referred to as NFc 120 and NFp 122. They may also be referred to as NF (service) consumer and NF (service) producer, respectively. As noted, the NFc and NFp may reside in the same PLMN or in different PLMNs.

A service communication proxy, SCP, 150, 152 may be deployed for indirect communication between network functions, NFs. An SCP is an intermediate network entity to assist in indirect communication between an NFc and an NFp, including routing messages, such as, for example, control plane messages between the NFs. The SCP may discover and select NFp on behalf of NFc. The SCP may request an access token from the NRF or an Authorization Server on behalf of NFc to access the service of NFp.

NF discovery and NF service discovery enable entities, such as NFc 120 or SCP 150, to discover a set of NF instance(s) and NF service instance(s) for a specific NF service or an NFp type. The NRF 140, 142 may comprise a function that is used to support the functionality of NF and NF service registration, NF and NF service discovery and NF status changes subscription and notification. Additionally or alternatively, the NRF may be configured to act as a service access authorization server. The NRF may maintain an NF profile of available NFp entities and their supported services. The NRF may notify about newly registered, updated, or deregistered NFp entities along with its NF services to a subscribed NFc or SCP. An NRF may thus advise NFc entities or SCP concerning where, that is, from which NFp entities, they may obtain services they need. An NRF may be co-located together with an SCP, for example, run in a same computing substrate. Alternatively, NRF may be in a physically distinct node than an SCP or even hosted by a service provider.

In order for the NFc 120 or SCP 150 to obtain information about the NFp and/or NF service(s) registered or configured in a PLMN/slice, the NFc 120 or SCP 150 may initiate, based on local configuration, a discovery procedure with an NRF, such as NRFc 140. The discovery procedure may be initiated by providing the type of the NFp and optionally a list of the specific service(s) it is attempting to discover. The NFc 120 or SCP 150 may additionally or alternatively provide other service parameters, such as information relating to network slicing.

Direct communication may be applied between NFc 120 and NFp 122 for an NF service, or NF service communication may be performed indirectly via SCP(s) 150, 152. In direct communication, the NFc 120 performs discovery of the target NFp 122 by local configuration or via local NRF, NRFc 140. In indirect communication, the NFc 120 may delegate the discovery of the target NFp 122 to the SCP 150. In the latter case, the SCP may use the parameters provided by NFc 120 to perform discovery and/or selection of the target NFp 122, for example with reference to one or more NRF. In 5G service based interface (SBI) model D, the NFc may delegate the NFp discovery and selection to the SCP and also delegate the service access authorization, i.e. delegate the access token retrieval for accessing the specific NFp's services to the SCP.

It is to be noted that at least some of the entities or nodes 120, 122, 140, 142 may act in both service-consuming and service-providing roles and that their physical structure may be similar or identical, while their role in the present examples in delivery of a particular message or service is identified by use of the prefix/suffix “c” or “p” indicating whether they are acting as the service-consuming or service-producing NF. It is to be noted that instead of “c” and “p”, “v” for visited and “h” for home can be used to refer to at least some respective entities in the visited and home PLMNs. In some embodiments, a system implementing an embodiment of the present disclosure comprises both fourth generation, 4G, and fifth generation, 5G, parts.

In general, a network support function such as an NRF may further be configured to act as a service access authorization server, and provide the NFc, or an SCP acting on behalf of the NFc, with a cryptographic access token authorizing the NFc to use the service provided by the NFp. The access token may also be referred to as an authorization token. In general, an NRF is a terminological example of a network support node. In general, an SCP is a terminological example of a proxy entity.

In some embodiments, OAuth based service authorization and/or token exchange is applied between NFc and NFp for the purpose of authorizing an NFc to access the service of an NFp. Alternatively to OAuth, another authorization framework may be applied. Thus, a network entity, such as an NRF, may be or perform as an authorization server, AS, such as an OAuth authorization server. The NFc may be an OAuth client and the NFp may operate as OAuth resource server, and they may be configured to support OAuth authorization framework as defined in IETF RFC 6749, for example.

The NFc or SCP may include the access token in a request message when requesting the service from the NFp, for example in an “authorization bearer” header. For example, the NRF may act as an OAuth 2.0 authorization server. The access token may comprise e.g. identifiers of the NFc, NRF and/or NFp, a timestamp and/or an identifier of the specific service which is authorized for the NFc with the access token. The access token may comprise a token identifier of itself, for example a serial number. The token identifier may uniquely identify the token. The access token may be cryptographically signed using a private key of the NRF. A validity of such a cryptographic signature may be verified using the corresponding public key of the NRF, which the NFp (or another entity validating the access token) may obtain in connection with registering with the NRF the service(s) it offers, for example. When the NFc contacts the NFp, it may present the access token, which the NFp may then verify, for example at least in part by using its copy of the public key of the NRF.

A subscribe-notify NF service allows an NFc to subscribe the service of the NF service producer, for instance NFp 122. The subscription request includes the notification endpoint, as an URI where a notification of the service, such as an event notification, by the NFp is to be sent. It is to be appreciated that this particular arrangement of system elements is an example only, and other types and arrangements of additional or alternative elements can be used to implement a communication system in other embodiments.

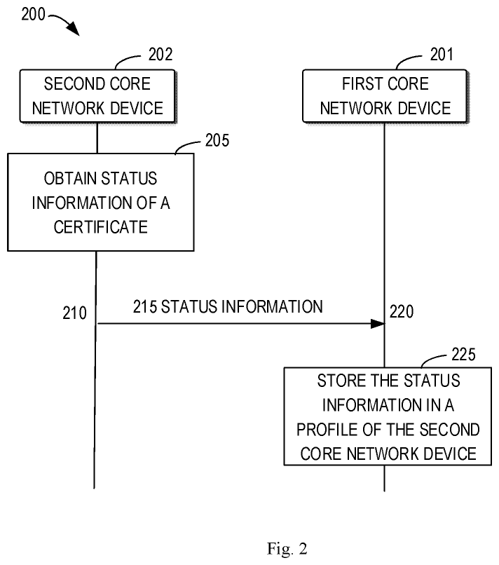

Reference is now made to FIG. 2, which shows an example of a process 200 of certificate management for network functions according to an embodiment of the present disclosure. It would be appreciated that the process flow 200 may be applied to the communication system 100 of FIG. 1 and any other similar communication scenarios.

In the process 200, a first core network device 201 and a second core network device 202 are involved in the certificate management for network functions. The first core network device 201 may be a NRF. The first core network device 201 may be any other suitable network element which stores profiles of NFs and manages the service access between the NFs. The second core network device 202 may be a NF service producer with its profile stored in the first core network device 201.

As shown in FIG. 2, the second core network device 202 obtains 205 status information of a certificate of the second core network device 202. The status information indicates validity of the certificate of the second core network device 202. In some embodiments, the status information may indicate that the certificate is valid. Alternatively or in addition, the status information may indicate that the certificate in invalid. For example, the certificate may be invalid due to revocation or expiry.

In some embodiments, the status information may comprise a timestamp indicating validity of the status information. In other words, the status information may be invalid due to expiry regardless of the validity of the certificate. In this case, even though the status information indicates that the certificate is valid, the status information itself may be considered as invalid.

In some embodiments, the status information may comprise online certificate status protocol (OCSP) stapling. The OCSP stapling, also known as TLS certificate status request extension, is a standard for checking revocation status of an X.509 digital certificate. It allows the presenter of a certificate to bear the resource cost involved in providing OCSP response by appending (“stapling”) a time-stamped OCSP response signed by certificate authority (CA) to the initial TLS handshake, thereby eliminating the need for clients to contact the CA. Alternatively or in addition, the status information may comprise any other information pertaining to the status of the certificate, for example, an indication of revocation or validity for the certificate.

In some embodiments, the second core network device 202 may obtain 205 the status information from a certificate status server. The certificate status server may be an OCSP server in a public key infrastructure (PKI). The PKI maintains the latest status of the certificate. Alternatively or in addition, the certificate status server may comprise any suitable server in the PKI providing the status of the certificate.

In some embodiments, the second core network device 202 may obtain 205 the status information from the certificate status server via an operation administration and maintenance (OAM) server. For example, when the second core network device 202 is instantiated by the OAM server or a cloud manager, the second core network device 202 or the OAM server may obtain 205 the status information from the certificate status server.

In some embodiments, the second core network device 202 may obtain 205 the status information by transmitting a request for the status information to the certificate status server and receiving a response comprising the status information from the certificate status server.

In some embodiments, the second core network device 202 may obtain 205 the status information periodically. For example, the second core network device 202 may transmit the request for the status information to the certificate status server periodically to obtain the status information periodically.

Alternatively or in addition, the second core network device 202 may transmit the request for the status information to the certificate status server based on determining that previous status information of the certificate at the second core network device 202 is expired or due to expire. For example, the second core network device 202 and/or the OAM server may keep track of the status information and renew it by contacting the certificate status server.

Alternatively or in addition, the second core network device 202 may transmit the request for the status information to the certificate status server based on a reboot of the second core network device 202. In some embodiments, if the second core network device 202 does not maintain persistency of the status information and gets rebooted, the second core network device 202 may request the status information again.

Alternatively or in addition, the second core network device 202 may transmit the request for the status information to the certificate status server based on receiving, from a server of the operator or the OAM server, an indication of updating the status information. The server of the operator or the OAM server may be configured with a policy to refresh or recreate the status information at the second core network device 202. For example, the OAM server may determine to update the status information at the second core network device 202 based on changing status of the second core network device 202. In this way, the status information of the certificate may be updated in accordance with an update of the status of the second core network device 202.

In some embodiments, the second core network device 202 may obtain 205 the status information without transmitting a request to the certificate status server. The certificate status server may keep updating the status information and transmit the latest status information to the second core network device 202 periodically.

Alternatively or in addition, the certificate status server may transmit the status information to the second core network device 202 based on determining that previous status information of the certificate transmitted to the second core network device 202 is expired or due to expire.

Alternatively or in addition, the certificate status server may transmit the status information to the second core network device 202 based on receiving, from the operator or the OAM server, an indication of updating previous status information of the certificate transmitted to the second core network device 202.

Alternatively or in addition, the certificate status server may transmit the status information to the second core network device 202 based on receiving, from the operator or the OAM server, an indication of a reboot of the second network device 202.

In some embodiments, as time goes on, the second core network device 202 may determine that the received status information expires. In this case, the second core network device 202 may report the expiry of the status information to the operator or the OAM server. In this way, the second core network device 202 may be managed accordingly in accordance with an update of the certificate lifecycle.

As shown in FIG. 2, the second core network device 202 transmits 210 the status information 215 of the certificate to the first core network device 201. In some embodiments, the second core network device 202 may transmit 210 the latest status information 215 to the first core network device 201 without checking the validity of the status information 215 or the validity of the certificate. Alternatively, the second core network device 202 may check the validity of the status information and/or the validity of the certificate before transmitting 210 the status information 215. The second core network device may transmit 210, to the first core network device 201, the valid status information 215 indicating that the certificate is valid.

In some embodiments, the second core network device 202 may transmit 210 the status information 215 to the first core network device 201 during registration of a profile of the second core network device 202 with the first core network device 201. Alternatively or in addition, the second core network device 202 may transmit 210 the status information 215 to the first core network device 201 during updating of the profile of the second core network device 202 with the first core network device 201. In other words, the second core network device 202 may transmit 210 the status information 215 while updating the profile with the first core network device 201.

The first core network device 201 receives 220 the status information 215 and stores 225 the status information 215 in a profile of the second core network device 202. In some embodiments, the first core network device 201 may store 225 the status information 215 in the profile by storing the status information 215 as a part of the profile. Alternatively or in addition, the first core network device 201 may store 225 the status information 215 in the profile by storing the status information 215 in association with the profile. Alternatively or in addition, the first core network device 201 may store 225 the status information 215 in the profile by updating the profile to contain an indication of the certificate status.

In some embodiments, the first core network device 201 may first receive 220 the profile during the registration and receive the status information 215 during the update of the profile. In this case, the first core network device 201 may store 225 the status information 215 in the updated profile.

In some embodiments, the first core network device 201 may store 225 the status information 215 in the profile without checking the validity of the status information 215 or the validity of the certificate. Alternatively, the first core network device 201 may store 225 the status information 215 after validating the status information 215 and/or the certificate.

It is to be noted that, the first core network device 201 may store the status information corresponding to a plurality of NFs comprising the second core network device 202. With the stored status information, the first core network device 201 may manage the services between the NFs more efficiently.

In some embodiments, the first core network device 201 may receive, from a third device, a request associated with a service provided by the second core network device 202. The request may be a NF discovery request for target NF(s) providing the service. Alternatively, the request may be an access token request for an access token used for accessing the service from the second core network device. Alternatively, the request may be a subscription request for subscribing to the second core network device 202.

The first core network device 201 may validate the status information 215 associated with the second core network device 202 to determine whether the second core network device 202 has a valid certificate. In some embodiments, the first core network device 201 may validate the status information 215 by determining that the status information 215 does not expire. Alternatively, the first core network device 201 may validate the status information 215 by determining that the status information 215 indicates a valid certificate and the status information 215 does not expire.

Based on determining that the second core network device 202 matches the received request and the second core network device 202 has a valid certificate, the first core network device 201 may consider the second core network device 202 in the response to the request from the third device.

In other words, for each NF service producer matching the received request, the first core network device 201 may validate the corresponding status information to determine whether its certificate is still valid. Based on determining that the certificate is still valid, the first core network device 201 may transmit, to the third device, a response for accessing service(s) provided by the matching NF service producer, e.g., the second core network device 202. In this way, the third device may be responded with a NF service producer having a valid certificate, thereby potential service failures can be reduced or avoided.

In some embodiments, based on determining that the status information 215 expires, the first core network device 201 may further report the expiry of the status information 215 to the server of the operator and/or the OAM server for management of a state of the second core network device 202. The server of the operator and/or the OAM server may determine the state of the second core network device 202 based on the status information 215.

In some embodiments, the OAM server may set the state of the second core network device 202 as suspended based on the expiry of the status information 215. Alternatively or in addition, the OAM server may set the state of the second core network device 202 as invalid based on absence of the status information 215 from the profile. In other words, in some embodiments, the absence of the status information 215 may indicate that the second core network device 202 has not transmitted the status information 215 to the first core network device 201 due to invalidity of its certificate.

Additionally, based on determining that the second core network device 202 is down or removed by the OAM server or the cloud manager, the OAM server may inactivate the profile of the second core network device 202 in the first core network device 201. Alternatively or in addition, based on determining that the second core network device 202 is down or removed, the OAM server may transmit an indication of revoking the certificate of the second core network device 202 to a server of CA or a registration authority (RA) for management of the certificate. As such, the certificate lifecycle and the NF lifecycle can be coordinated efficiently.

With the process 200, the successful TLS connection between the NF service customer and the NF service producer may be ensured to avoid NF service failures. Moreover, with the status information stored, e.g., cached in the first core network device 201, the first core network device 201 does not need to query for the certificate status of each NF service producer in response to each service request, thereby reducing the load on the first core network device 201 and providing a faster and real time response to the request from the NF service customer. Also, with the stored status information, a resilient approach can be provided in case of outage of the certificate status server.

Moreover, by using the OCSP stapling as the status information, a scalable approach can be provided despite of the number of revoked certificates because the first core network device 201 does not need to fetch certificate revocation lists (CRLs) and to validate the certificate against the CRLs.

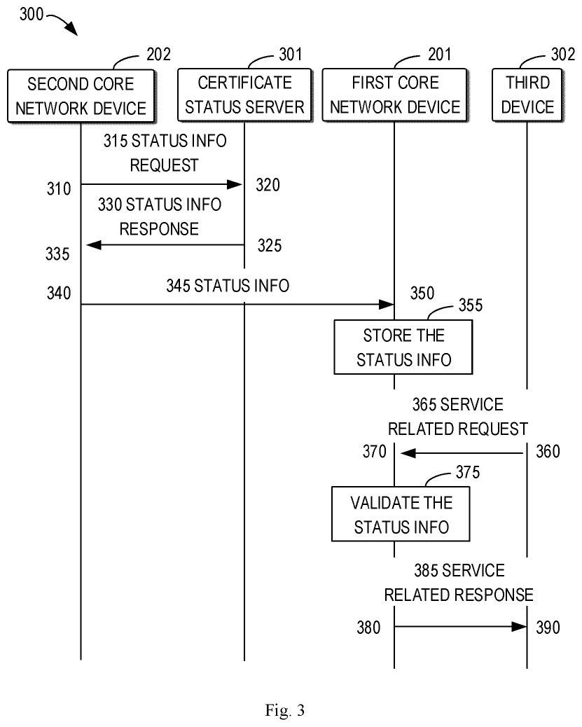

FIG. 3 illustrates another example of a process 300 of certificate management for network functions according to an embodiment of the present disclosure. It is noted that the process 300 can be deemed as a more specific example of the process 200. It would be appreciated that the process 300 may be applied to the communication system 100 of FIG. 1 and any other similar communication scenarios.

As shown in FIG. 3, the first core network device 201, the second core network device 202, a certificate status server 301 and a third device 302 are involved in the process 300 of the certificate management for the network functions. As described above, in some embodiments, the first core network device 210 may be a network repository function, and the second core network device 202 may be a NF service producer. In some embodiments, the certificate status server 301 may be the PKI, or any suitable server in the PKI. For example, the certificate status server 301 may be an OCSP server. In some embodiments, the third device 302 may be a core network device. Alternatively, the third device 302 may be an access network device or any other suitable device. The third device 302 may be a NF service customer.

The second core network device 202 may transmit 310 a status information request 315 to the certificate status server 301. As mentioned above, the second core network device 202 may transmit 310 the status information request 315 periodically or based on determining that previous status information of the certificate is due to expire.

The certificate status server 301 may receive 320 the status information request 315 and obtain the status of the certificate of the second core network device 202. The certificate status server 301 may maintain the latest status of the certificate and keep updating the status of the certificate. The certificate status server 301 may transmit 325 a status information response 330 to the second core network device 202 to provide the status information of the certificate of the second core network device 202.

In some embodiments, the status information request 315 may be an OCSP stapling request for an end-entity certificate of the second core network device 202. The status information response 330 may be an OCSP stapling response with expiry.

Based on receiving 335 the status information response 330, the second core network device 202 may transmit 340 the status information 345 to the first core network device 201. In some embodiments, the second core network device 202 may transmit 340 the status information 345 during registration of its profile with the first core network device 201. Alternatively or in addition, the second core network device 202 may transmit 340 the status information 345 during updating of its profile with the first core network device 201. Alternatively, the second core network device 202 may transmit 340 the status information 345 and its profile separately.

Based on receiving 350 the status information 345, the first core network device 201 may store 355 the status information 345 in the profile of the second core network device 202. The first core network device 201 may store and maintain other status information corresponding to other NF service producers.

The third device 302 may transmit 360 a service related request 365 to the first core network device for accessing service(s) from NF service producer(s). Based on receiving 370 the service related request 365, the first core network device 201 may identify, based on stored profiles of a plurality of core network devices and corresponding status information, one or more NF service producers that match the service related request 365 and have valid certificates. The first core network device 201 may identify the one or more NF service producers by validating 375 the status information to determine whether the certificates are still valid.

Based on the one or more identified NF service producers, the first core network device 201 may transmit 380 a service related response 385 to the third device 302 in response to the service related request 365. The third device 302 may receive 390 the service related response 385 and access the service(s) based on the received service related response 385.

As an example, the service related request 365 may be a NF discovery request which contains a certain NF type and the service related response 385 may be a NF discovery response. As another example, the service related request 365 may be an access token request and the service related response 385 may be an access token response. As yet another example, the service related request 365 may be a subscription request and the service related response 385 may be a subscription response.

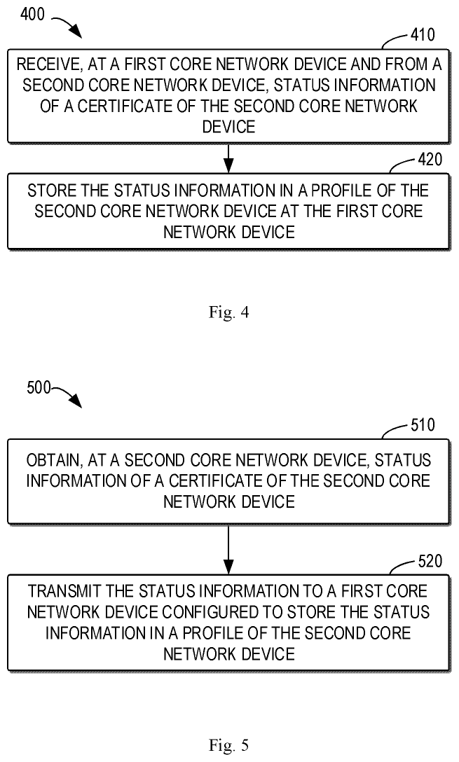

FIG. 4 shows a flowchart of an example method 400 implemented at a first core network device in accordance with some embodiments of the present disclosure. For the purpose of discussion, the method 400 will be described from the perspective of the first core network device 201 with reference to FIG. 2.

At block 410, the first core network device 201 receives, at the first core network device 201 and from a second core network device 202, status information of a certificate of the second core network device. At block 420, the first core network device 201 stores the status information in a profile of the second core network device 202 at the first core network device 201.

In some embodiments, the first core network device 201 may further receive, from a third device, a request associated with a service provided by the second core network device. The first core network device 201 may further validate the stored status information of the certificate to determine whether the certificate is still valid; and based on determining that the certificate is still valid, transmit, to the third device, a response for accessing the service provided by the second core network device.

In some embodiments, the first core network device 201 may receive the status information by at least one of: receiving the status information during registration of the profile of the second core network device with the first core network device, or receiving the status information during updating of the profile of the second core network device with the first core network device.

In some embodiments, the status information comprises a timestamp indicating validity of the status information.

In some embodiments, the first core network device 201 may validate the stored status information by: determining that the status information does not expire.

In some embodiments, the request from the third device comprises at least one of: a network function (NF) discovery request, an access token request, or a subscription request.

In some embodiments, the first core network device 201 may further based on determining that the status information expires, report expiry of the status information to a server of an operator or an operation administration and maintenance (OAM) server for management of a state of the second core network device.

In some embodiments, the OAM server is further caused to perform at least one of the following based on determining that the second core network device is down or removed: inactivating the profile of the second core network device in the first core network device, or transmitting an indication of revoking the certificate of the second core network device to a server of a certificate authority or a registration authority for management of the certificate.

In some embodiments, the status information at least comprises online certificate status protocol (OCSP) stapling.
FIG. 5 shows a flowchart of an example method 500 implemented at a second core network device in accordance with some embodiments of the present disclosure. For the purpose of discussion, the method 500 will be described from the perspective of the second core network device 202 with reference to FIG. 2.

At block 510, the second core network device 202 obtains, at the second core network device 202, status information of a certificate of the second core network device 202. At block 520, the second core network device 202 transmits, at the second core network device 202, the status information to a first core network device 201 configured to store the status information in a profile of the second core network device 202.

In some embodiments, the second core network device 202 may transmit the status information by at least one of: transmitting the status information to the first core network device during registration of the profile of the second core network device with the first core network device, or transmitting the status information to the first core network device during updating of the profile of the second core network device with the first core network device.

In some embodiments, the status information comprises a timestamp indicating validity of the status information.

In some embodiments, the second core network device 202 may obtain the status information by: obtaining the status information from a certificate status server periodically.

In some embodiments, the second core network device 202 may obtain the status information by: transmitting a request for the status information to a certificate status server; and receiving a response comprising the status information from the certificate status server.

In some embodiments, the second core network device 202 may transmit the request for the status information based on at least one of: determining that previous status information of the certificate at the second core network device is to expire, receiving, from a server of an operator or an operation administration and maintenance (OAM) server, an indication of updating the status information, or a reboot of the second core network device.

In some embodiments, the second core network device 202 may obtain the status information by: receiving, from a certificate status server, the status information determined by the certificate status server based on at least one of: determining that previous status information of the certificate transmitted to the second core network device is to expire, receiving, from a server of an operator or an OAM server, an indication of updating previous status information of the certificate transmitted to the second core network device, or receiving, from a server of an operator or an OAM server, an indication of a reboot of the second network device.

In some embodiments, the second core network device 202 may further based on determining that the status information expires, report expiry of the status information to a server of an operator or an OAM server.

In some embodiments, the status information at least comprises online certificate status protocol (OCSP) stapling.

In some embodiments, an apparatus capable of performing any of the method 400 (for example, the first core network device 201) may comprise means for performing the respective steps of the method 400. The means may be implemented in any suitable form. For example, the means may be implemented in a circuitry or software module.

In some embodiments, the apparatus comprises: means for receiving, at a first core network device and from a second core network device, status information of a certificate of the second core network device; and means for storing the status information in a profile of the second core network device at the first core network device.

In some embodiments, the apparatus may further comprise: means for receiving, from a third device, a request associated with a service provided by the second core network device; means for validating the stored status information of the certificate to determine whether the certificate is still valid; and means for based on determining that the certificate is still valid, transmitting, to the third device, a response for accessing the service provided by the second core network device.

In some embodiments, the means for receiving the status information may comprise means for receiving the status information by at least one of: receiving the status information during registration of the profile of the second core network device with the first core network device, or receiving the status information during updating of the profile of the second core network device with the first core network device.

In some embodiments, the status information comprises a timestamp indicating validity of the status information.

In some embodiments, the means for validating the stored status information may comprise means for determining that the status information does not expire.

In some embodiments, the request from the third device comprises at least one of: a network function (NF) discovery request, an access token request, or a subscription request.

In some embodiments, the apparatus may further comprise means for based on determining that the status information expires, reporting expiry of the status information to a server of an operator or an operation administration and maintenance (OAM) server for management of a state of the second core network device.

In some embodiments, the status information at least comprises online certificate status protocol (OCSP) stapling.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus.

In some embodiments, an apparatus capable of performing any of the method 500 (for example, the second core network device 202) may comprise means for performing the respective steps of the method 500. The means may be implemented in any suitable form. For example, the means may be implemented in a circuitry or software module.

In some embodiments, the apparatus comprises: means for obtaining, at a second core network device, status information of a certificate of the second core network device; and means for transmitting, at the second core network device, the status information to a first core network device configured to store the status information in a profile of the second core network device.

In some embodiments, the means for transmitting the status information may comprise means for transmitting the status information by at least one of: transmitting the status information to the first core network device during registration of the profile of the second core network device with the first core network device, or transmitting the status information to the first core network device during updating of the profile of the second core network device with the first core network device.

In some embodiments, the status information comprises a timestamp indicating validity of the status information.

In some embodiments, the means for obtaining the status information may comprise means for obtaining the status information from a certificate status server periodically.

In some embodiments, the means for obtaining the status information may comprise means for: transmitting a request for the status information to a certificate status server; and receiving a response comprising the status information from the certificate status server.

In some embodiments, the means for transmitting the request may comprise means for transmitting the request based on at least one of: determining that previous status information of the certificate at the second core network device is to expire, receiving, from a server of an operator or an operation administration and maintenance (OAM) server, an indication of updating the status information, or a reboot of the second core network device.

In some embodiments, the means for obtaining the status information may comprise means for: receiving, from a certificate status server, the status information determined by the certificate status server based on at least one of: determining that previous status information of the certificate transmitted to the second core network device is to expire, receiving, from a server of an operator or an OAM server, an indication of updating previous status information of the certificate transmitted to the second core network device, or receiving, from a server of an operator or an OAM server, an indication of a reboot of the second network device.

In some embodiments, the apparatus may further comprise means for based on determining that the status information expires, reporting expiry of the status information to a server of an operator or an OAM server.

In some embodiments, the status information at least comprises online certificate status protocol (OCSP) stapling.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

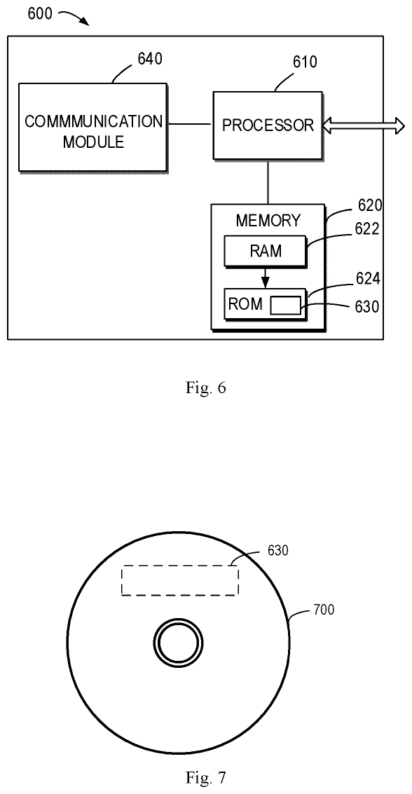

FIG. 6 is a simplified block diagram of a device 600 that is suitable for implementing embodiments of the present disclosure. The device 600 may be provided to implement the communication device, for example the first core network device 201, or the second core network device 202 as shown in FIG. 2. As shown, the device 600 includes one or more processors 610, one or more memories 640 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 1-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-23. (canceled)

24. A first core network device comprising:
at least one processor; and
at least one memory storing instructions that, when executed by the at least one processor, cause the first core network device at least to:
receive, from a second core network device, status information of a certificate of the second core network device; and
store the status information in a profile of the second core network device.

25. The first core network device of claim 24, wherein the first core network device is further caused to:
receive, from a third device, a request associated with a service provided by the second core network device;
validate the stored status information of the certificate to determine whether the certificate is still valid; and
based on determining that the certificate is still valid, transmit, to the third device, a response for accessing the service provided by the second core network device.

26. The first core network device of claim 24, wherein the first core network device is caused to receive the status information by at least one of:
receiving the status information during registration of the profile of the second core network device with the first core network device, or
receiving the status information during updating of the profile of the second core network device with the first core network device.

27. The first core network device of claim 24, wherein the status information comprises a timestamp indicating validity of the status information.

28. The first core network device of claim 25, wherein the first core network device is caused to validate the stored status information by:
determining that the status information does not expire.

29. The first core network device of claim 25, wherein the request from the third device comprises at least one of:
a network function (NF) discovery request,
an access token request, or
a subscription request.

30. The first core network device of claim 24, wherein the first core network device is further caused to:
based on determining that the status information expires, report expiry of the status information to a server of an operator or an operation administration and maintenance (OAM) server for management of a state of the second core network device.

31. The first core network device of claim 30, wherein the OAM server is further caused to perform at least one of the following based on determining that the second core network device is down or removed:
inactivating the profile of the second core network device in the first core network device, or
transmitting an indication of revoking the certificate of the second core network device to a server of a certificate authority or a registration authority for management of the certificate.

32. The first core network device of claim 24, wherein the status information at least comprises online certificate status protocol (OCSP) stapling.

33. A second core network device comprising:
at least one processor; and
at least one memory storing instructions that, when executed by the at least one processor, cause the second core network device at least to:
obtain status information of a certificate of the second core network device; and
transmit the status information to a first core network device configured to store the status information in a profile of the second core network device.

34. The second core network device of claim 33, wherein the second core network device is caused to transmit the status information by at least one of:
transmitting the status information to the first core network device during registration of the profile of the second core network device with the first core network device, or transmitting the status information to the first core network device during updating of the profile of the second core network device with the first core network device.

35. The second core network device of claim 33, wherein the status information comprises a timestamp indicating validity of the status information.

36. The second core network device of claim 33, wherein the second core network device is caused to obtain the status information by:
obtaining the status information from a certificate status server periodically.

37. The second core network device of claim 33, wherein the second core network device is caused to obtain the status information by:
transmitting a request for the status information to a certificate status server; and
receiving a response comprising the status information from the certificate status server.

38. The second core network device of claim 37, wherein the second core network device is caused to transmit the request for the status information based on at least one of:
determining that previous status information of the certificate at the second core network device is to expire,
receiving, from a server of an operator or an operation administration and maintenance (OAM) server, an indication of updating the status information, or
a reboot of the second core network device.

39. The second core network device of claim 33, wherein the second core network device is caused to obtain the status information by:
receiving, from a certificate status server, the status information determined by the certificate status server based on at least one of:
determining that previous status information of the certificate transmitted to the second core network device is to expire,
receiving, from a server of an operator or an OAM server, an indication of updating previous status information of the certificate transmitted to the second core network device, or
receiving, from a server of an operator or an OAM server, an indication of a reboot of the second network device.

40. The second core network device of claim 33, wherein the second core network device is further caused to:
based on determining that the status information expires, report expiry of the status information to a server of an operator or an OAM server.

41. The second core network device of claim 33, wherein the status information at least comprises online certificate status protocol (OCSP) stapling.
